(19) United States
(12) Patent Application Publication
(10) Pub. No.: US 2025/0218020 A1
(43) Pub. Date: Jul. 3, 2025

(54) DEPTH MAP GENERATION METHOD USING PREVIOUS FRAME INFORMATION FOR FAST DEPTH ESTIMATION

(71) Applicant: Korea Electronics Technology Institute, Seongnam-si (KR)

(72) Inventors: Jin Man PARK, Gwangju-si (KR); Young Bo SHIM, Seongnam-si (KR); Jae Woong YOO, Seongnam-si (KR); Yong Hyeon CHO, Seoul (KR); Kyoung Won MIN, Seongnam-si (KR); Haeng Seon SON, Seongnam-si (KR); Seon Young LEE, Seoul (KR); Gi Ho SUNG, Seongnam-si (KR)

(73) Assignee: Korea Electronics Technology Institute, Seongnam-si (KR)

(21) Appl. No.: 18/975,445

(22) Filed: Dec. 10, 2024

(30) Foreign Application Priority Data
Dec. 28, 2023 (KR) 10-2023-0193784

(51) Int. Cl. G06T 7/593; G06T 3/40; G06T 7/20; G06V 10/771

(52) U.S. Cl. CPC G06T 7/593; G06T 3/40; G06T 7/20; G06V 10/771; G06T 2207/10012; G06T 2207/20084

(57) ABSTRACT

Provided is a depth map generation method using previous frame information. A depth map generation method according to an embodiment of the disclosure extracts a feature map of a 1/n scale resolution on a stereo image of a current frame, and generates a depth map of a 1/n scale resolution of the current frame by using a depth map of a 1/n scale resolution on a stereo image of a previous frame, and the extracted feature map. Accordingly, a depth map of a current frame is generated by using a depth map of a previous frame based on continuity of information between continuous frames of a moving image, so that efficient use of resources, reduction of a calculation response time, enhancement of accuracy are possible.

### CROSS-REFERENCE TO RELATED APPLICATION(S) AND CLAIM OF PRIORITY

This application is based on and claims priority under 35 U.S.C. § 119 to Korean Patent Application No. 10-2023-0193784, filed on Dec. 28, 2023, in the Korean Intellectual Property Office, the disclosure of which is herein incorporated by reference in its entirety.

### BACKGROUND

### Field

The disclosure relates to depth map generation, and more particularly, to a method for swiftly generating a depth map from a stereo image.

### Description of Related Art

In the computer vision field, monocular/stereo depth map extraction is the most basic technology that should precede to implement 3D applications. With the development of deep learning, this technology has gradually enhanced its accuracy and speed, but still has difficulty in guaranteeing high-resolution images and 30 Hz real-time when an embedded device is used.

In the related-art monocular/stereo depth map extraction technology, feature pyramids of various resolutions are extracted by using a current frame image, and a depth map is generated by using the features.

The fundamental problem of this method is that the advantages of moving images are not used. That is, the problem is that information of a previous frame is never used, and thus all processing steps should be performed from the first step when a current frame comes in.

Many portions between neighboring frames in a moving image may have similar structures and patterns. However, if the consistency between the depth map information of a previous frame and a current frame breaks down, the process of newly calculating the depth map for each frame inevitably increases the time and calculation cost. This inefficiency may be fatal especially in real-time applications.

### SUMMARY

The disclosure has been developed in order to solve the above-described problems, and an object of the disclosure is to provide, as a solution for fast calculation to enable real-time depth estimation, a method for generating a depth map of a current frame by using a depth map of a previous frame based on continuity of information between continuous frames of a moving image.

To achieve the above-described object, a depth map generation method according to an embodiment of the disclosure may include: a step of extracting a feature map of a 1/n scale resolution on a stereo image of a current frame; and a first generation step of generating a depth map of a 1/n scale resolution of the current frame by using a depth map of a 1/n scale resolution on a stereo image of a previous frame, and the extracted feature map.

The first generation step may include: a step of warping the depth map of the 1/n scale resolution of the previous frame; and a second generation step of generating the depth map of the 1/n scale resolution of the current frame by using the warped depth map and the extracted feature map.

The step of warping may include: a step of calculating an optical flow between the previous frame and the current frame; and a step of warping the depth map of the previous frame by using the calculated optical flow.

The second generation step may include generating the depth map of the current frame from the warped depth map and the extracted feature map, by using a neural network that is trained to generate a depth map of a current frame from a feature map and a depth map of a previous frame.

When the current frame is a first frame, the step of warping may not be performed, and the second generation step may include generating the depth map of the 1/n scale resolution of the current frame by using a depth map which is filled with 0 and the extracted feature map.

According to the disclosure, the depth map generation method may further include a step of up-scaling the depth map generated at the second generation step to an original scale resolution.

The step of up-scaling may include up-scaling the depth map generated at the second generation step to the original scale resolution by using a neural network that is trained to generate a depth map of an original scale resolution from a depth map of a 1/n scale resolution.

n may be a single value.

The step of extracting may include extracting a feature map of a 1/n scale resolution on a left-eye image and a feature map of a 1/n scale resolution on a right-eye image.

According to another aspect of the disclosure, there is provided a depth map generation system including: an extraction unit configured to extract a feature map of a 1/n scale resolution on a stereo image of a current frame; and a generation unit configured to generate a depth map of a 1/n scale resolution of the current frame by using a depth map of a 1/n scale resolution on a stereo image of a previous frame, and the extracted feature map.

According to still another aspect of the disclosure, there is provided a depth map generation method including: a step of warping a depth map of a 1/n scale resolution on a stereo image of a previous frame; a step of generating a depth map of a 1/n scale resolution of a current frame by using the warped depth map and a feature map of a 1/n scale resolution which is extracted from a stereo image of a current frame; and a step of up-scaling the generated depth map to an n scale resolution.

As described above, according to embodiments of the disclosure, by generating a depth map of a current frame by using a depth map of a previous frame based on continuity of information between continuous frames of a moving image, the following advantageous effects may be provided:
1) Efficient use of resources: The method may infer a depth map with less calculation resources compared to a related-art method, so that power consumption and memory usage are reduced.
2) Reduction of a response time: A response time in a real-time application program is reduced due to the enhancement of depth map inference speed, so that user experience is enhanced.
3) Improved accuracy: The accuracy of a depth map is enhanced by using information of a previous frame, and this contributes to performance enhancement particularly in a dynamic environment.
4) Application to various environments: The technical effect of the disclosure may be achieved even in an embedded system and a mobile device with resource restrictions.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a configuration of a depth map generation system to which an embodiment of the disclosure is applicable;

FIG. 2 is a view illustrating a configuration of a depth map generation system according to an embodiment of the disclosure;

FIG. 3 is a view illustrating a result of testing by a depth map estimation method according to an embodiment of the disclosure;

FIG. 4A is a view illustrating a result of testing by a depth map estimation method according to an embodiment of the disclosure;

FIG. 4B is a view illustrating a result of testing by a depth map estimation method according to an embodiment of the disclosure; and

FIG. 5 is a view illustrating a configuration of an AI stereo camera according to another embodiment of the disclosure.

### DETAILED DESCRIPTION

Hereinafter, the disclosure will be described in more detail with reference to the accompanying drawings.

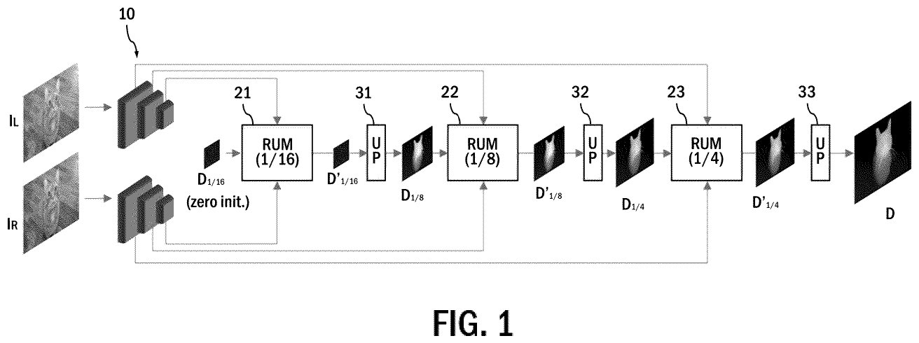

FIG. 1 is a view illustrating a configuration of a depth map generation system to which an embodiment of the disclosure is applicable. The depth map generation system according to an embodiment generates a depth map of a current frame by using only a current frame, and specifically, uses the following components:

A pyramid feature extraction unit 10 which extracts a pyramid feature map by applying the same backbone network to left and right stereo images, wherein a scale of ¼, ⅛, ⅙ of the original image resolution is used for the feature map; and

A depth map enhancement unit 21, 22, 23 and an up-scaling unit 31, 32, 33 which gradually generate a depth map of a high resolution from a depth map of a low-resolution. In the example of FIG. 1, the depth map of the original scale resolution is generated starting from the depth map of the 1/16 scale resolution.

Specifically, the depth map enhancement unit-1 21 generates the depth map of the 1/16 scale resolution from the feature map of the 1/16 scale resolution extracted by the pyramid feature extraction unit 10 and from the initial depth map of the 1/16 scale resolution (all pixels being filled with 0), and the up-scaling unit-1 131 up-scales the depth map of the 1/16 scale resolution outputted from the depth map enhancement unit-1 21 to the depth map of the ⅛ scale resolution.

The depth map enhancement unit-2 22 generates the depth map of the ⅛ scale resolution with enhanced quality from the depth map of the ⅛ scale resolution, which is outputted from the up-scaling unit-1 31, and the feature map of the ⅛ scale resolution which is extracted by the pyramid feature extraction unit 10, and the up-scaling unit-2 32 up-scales the depth map of the ⅛ scale resolution outputted from the depth map enhancement unit-2 22 to the depth map of the ¼ scale resolution.

Thereafter, the depth map enhancement unit-3 23 generates the depth map of the ¼ scale resolution with enhanced quality from the depth map of the ¼ scale resolution, which is outputted from the up-scaling unit-2 32, and the feature map of the ¼ scale resolution which is extracted by the pyramid feature extraction unit 10, and the up-scaling unit-3 33 up-scales the depth map of the ¼ scale resolution outputted from the depth map enhancement unit-3 23 to the depth map of the original scale resolution.

Embodiments of the disclosure propose a method for generating a depth map by using previous frame information to enhance depth estimation speed and to offset quality degradation resulting therefrom.

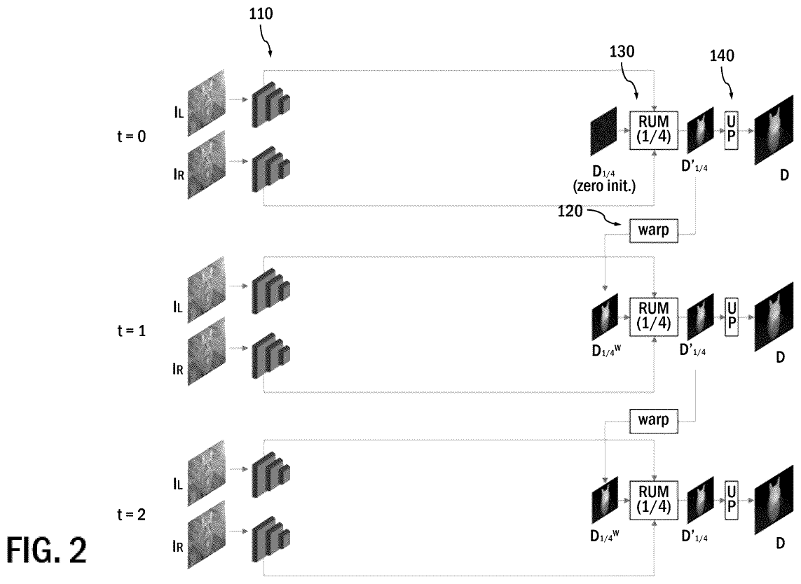

FIG. 2 is a view illustrating a configuration of a depth map generation system according to an embodiment of the disclosure. The depth map generation system according to an embodiment of the disclosure may include a feature extraction unit 110, a warping unit 120, a depth map generation unit 130, and an up-scaling unit 130 as shown in the drawing.

The feature extraction unit 110 is configured to extract a feature map of a ¼ scale resolution on a stereo image of a current frame. Specifically, the feature extraction unit 110 extracts a feature map of a ¼ scale resolution on a left-eye image, and a feature map of a ¼ scale resolution on a right-eye image.

The feature extraction unit 110 may be implemented by a typical backbone neural network which extracts features from an image. However, the backbone neural network for extracting the feature map from the left-eye image and the backbone network for extracting the feature map from the right-eye image are required to be the same.

The feature extraction unit 110 differs from the feature extraction unit 10 of FIG. 1, which extracts a pyramid feature map having several resolutions, in that the feature map extracted by the feature extraction unit 110 has a single scale resolution.

The warping unit 120 calculates an optical flow between a previous frame and a current frame, and warps the depth map of the ¼ scale resolution of the previous frame by using the calculated optical flow.

The depth map generation unit 130 generates a depth map of a ¼ scale resolution of the current frame from the feature map of the ¼ scale resolution which is extracted by the feature extraction unit 110, and the depth map of the ¼ scale resolution of the previous frame which is warped by the warping unit 120.

When there is no depth map of the previous frame warped, that is, when the current frame is the first frame, the depth map generation unit 130 uses an initial depth map of a ¼ scale resolution which is filled with 0, instead of the depth map of the previous frame warped.

The depth map generation unit 130 may generate the depth map of the current frame from the extracted feature map and the warped depth map, by using a neural network that is trained to generate a depth map of a current frame from a feature map and a depth map of a previous frame.

The up-scaling unit 140 up-scales the depth map of the ¼ scale resolution, which is outputted from the depth map generation unit 130, to the depth map of the original scale resolution.

The up-scaling unit 140 may up-scale the generated depth map by using a neural network that is trained to generate a depth map of an original scale resolution from a depth map of a ¼ scale resolution.

A process of generating a depth map in the unit of a frame in the depth map generation system according to an embodiment of the disclosure will be described step by step.

—First Frame (t=0)
1) The feature extraction unit 110 extracts a feature map of a ¼ scale resolution on a stereo image of a current frame.
2) Since there is no previous frame, the warping unit 120 does not operate.
3) The depth map generation unit 130 generates a depth map of a ¼ scale resolution of the current frame from the feature map of the ¼ scale resolution which is extracted at the step of ‘1)’, and an initial depth map of a ¼ scale resolution filled with 0.
4) The up-scaling unit 140 up-scales the depth map of the ¼ scale resolution generated at the step of ‘3)’ to the depth map of the original scale resolution.
   —Second Frame (t=1)
1) The feature extraction unit 110 extracts a feature map of a ¼ scale resolution on a stereo image of a current frame.
2) The warping unit 120 calculates an optical flow between the previous frame and the current frame, and warps the depth map of the ¼ scale resolution of the previous frame by using the calculated optical flow.
3) The depth map generation unit 130 generates a depth map of a ¼ scale resolution of the current frame from the feature map of the ¼ scale resolution extracted at step of ‘1)’, and the depth map of the ¼ scale resolution of the previous frame warped at the step of ‘2)’.
4) The up-scaling unit 140 up-scales the depth map of the ¼ scale resolution generated at the step of ‘3)’ to the depth map of the original scale resolution.
   —Third Frame (t=2) and Subsequent Frames (t>=3)

The same steps as in the second frame (t=1) are performed.

In embodiments of the disclosure, calculation is fast since only the ¼ scale resolution is used except for a ⅛ scale resolution and a 1/16 scale resolution, and the accuracy is enhanced since the depth map of the previous frame highly related to the current frame is used for generating the depth map.

At the initial stage of frames, the accuracy may be lower than when the depth map is generated only with the current frame, but, when several frames pass, correct depth information is shortly accumulated and quality degradation occurs for a very short period at the initial stage.

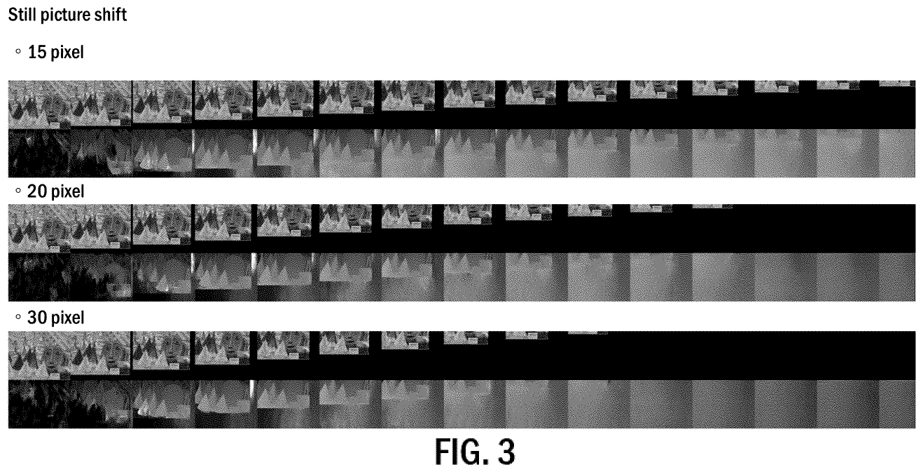

FIG. 3 shows a result of testing by a depth map estimation method according to an embodiment of the disclosure. Depth estimation was tested with a moving image that is made by shifting the same image by a predetermined number of pixels in the vertical direction.

As shown in FIG. 3, the result of testing shows that the method according to an embodiment of the disclosure (the proposed method, FIG. 2) provides stable depth estimation quality even when the image is shifted by 30 pixels/frames.

In addition, the method (the proposed method, FIG. 2) according to an embodiment of the disclosure shows that the depth estimation equality is not good at the initial stage, but is enhanced after 4 to 5 frames.

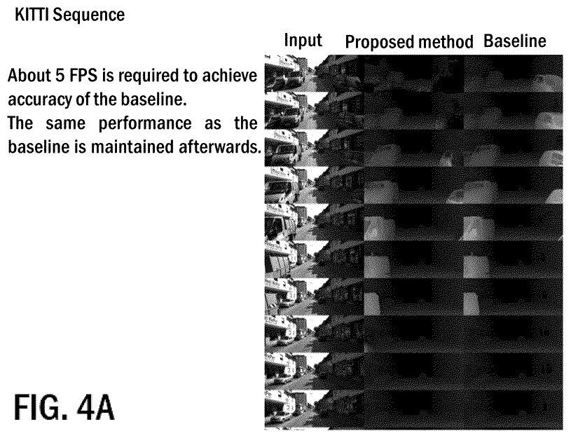

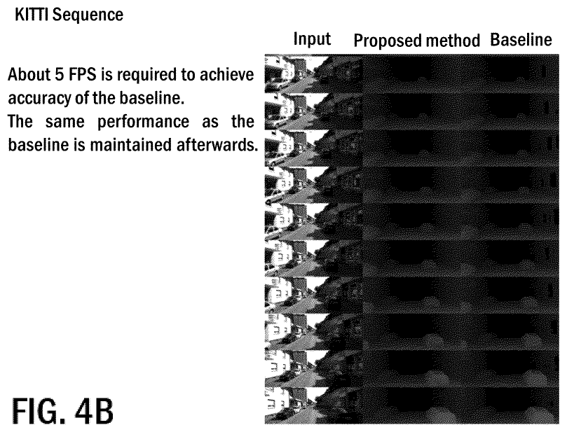

FIGS. 4A and 4B show results of testing by using travel image datasets obtained in an autonomous car that the applicant owns. The result of testing shows that the method (the proposed method, FIG. 2) according to an embodiment of the disclosure increases depth estimation speed by about 25% compared to a related art method (baseline, FIG. 1).

In addition, the method (the proposed method, FIG. 2) according to an embodiment of the disclosure shows that the depth estimation equality is not good at the initial stage, but is enhanced up to the same level as in the related-art method (baseline, FIG. 1) after 4 to 5 frames.

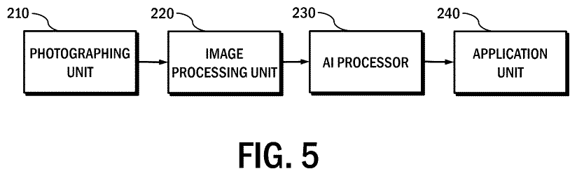

FIG. 5 is a view illustrating a configuration of an AI stereo camera according to another embodiment of the disclosure. The AI stereo camera according to an embodiment of the disclosure is a camera that not only acquires a stereo image but also generates a depth map.

The AI stereo camera according to an embodiment of the disclosure may include a photographing unit 210, an image processing unit 220, an AI processor 230, and an application unit 240 as shown in the drawing.

The photographing unit 210 acquires a stereo image comprised of a left-eye image and a right-eye image. The image processing unit 220 performs necessary image processing with respects to the stereo image acquired by the photographing unit 210.

The AI processor 230 executes the depth map generation system proposed in FIG. 2 to generate a depth map from the stereo image signal-processed in the image processor 220 in real time.

The application unit 240 provide a 3D application service by using the image generated by the photographing unit 210 and the depth map generated by the AI processor 230.

Up to now, the method for generating a depth map by using previous frame information for fast depth estimation has been described in detail with reference to preferred embodiments.

In the above-described embodiments, a depth map of a current frame is generated by using a depth map of a previous frame based on continuity of information between continuous frames of a moving image, so that efficient use of resources, reduction of a calculation response time, enhancement of accuracy are possible.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A depth map generation method comprising:
a step of extracting a feature map of a 1/n scale resolution on a stereo image of a current frame; and
a first generation step of generating a depth map of a 1/n scale resolution of the current frame by using a depth map of a 1/n scale resolution on a stereo image of a previous frame, and the extracted feature map.

2. The depth map generation method of claim 1, wherein the first generation step comprises:
a step of warping the depth map of the 1/n scale resolution of the previous frame; and
a second generation step of generating the depth map of the 1/n scale resolution of the current frame by using the warped depth map and the extracted feature map.

3. The depth map generation method of claim 2, wherein the step of warping comprises:
a step of calculating an optical flow between the previous frame and the current frame; and
a step of warping the depth map of the previous frame by using the calculated optical flow.

4. The depth map generation method of claim 2, wherein the second generation step comprises generating the depth map of the current frame from the warped depth map and the extracted feature map, by using a neural network that is trained to generate a depth map of a current frame from a feature map and a depth map of a previous frame.

5. The depth map generation method of claim 2, wherein, when the current frame is a first frame, the step of warping is not performed, and the second generation step comprises generating the depth map of the 1/n scale resolution of the current frame by using a depth map which is filled with 0 and the extracted feature map.

6. The depth map generation method of claim 1, further comprising a step of up-scaling the depth map generated at the second generation step to an original scale resolution.

7. The depth map generation method of claim 6, wherein the step of up-scaling comprises up-scaling the depth map generated at the second generation step to the original scale resolution by using a neural network that is trained to generate a depth map of an original scale resolution from a depth map of a 1/n scale resolution.

8. The depth map generation method of claim 1, wherein n is a single value.

9. The depth map generation method of claim 1, wherein the step of extracting comprises extracting a feature map of a 1/n scale resolution on a left-eye image and a feature map of a 1/n scale resolution on a right-eye image.

10. A depth map generation system comprising:
an extraction unit configured to extract a feature map of a 1/n scale resolution on a stereo image of a current frame; and
a generation unit configured to generate a depth map of a 1/n scale resolution of the current frame by using a depth map of a 1/n scale resolution on a stereo image of a previous frame, and the extracted feature map.

11. A depth map generation method comprising:
a step of warping a depth map of a 1/n scale resolution on a stereo image of a previous frame;
a step of generating a depth map of a 1/n scale resolution of a current frame by using the warped depth map and a feature map of a 1/n scale resolution which is extracted from a stereo image of a current frame; and
a step of up-scaling the generated depth map to an n scale resolution.
